(19) United States
(12) Patent Application Publication
(10) Pub. No.: US 2024/0336071 A1
(43) Pub. Date: Oct. 10, 2024

(54) PRINTING APPARATUS AND INK CIRCULATION METHOD

(71) Applicant: CANON KABUSHIKI KAISHA, Tokyo (JP)

(72) Inventors: YOSHIYUKI HONDA, Kanagawa (JP); TAKAO OGATA, Tokyo (JP); TAKU HIGASHIYAMA, Kanagawa (JP); KYOSUKE DEGUCHI, Kanagawa (JP); DAISUKE YOSHITOKU, Kanagawa (JP); SHUNSUKE KAKEI, Kanagawa (JP); AKIHIRO MOURI, Tokyo (JP)

(21) Appl. No.: 18/624,016

(22) Filed: Apr. 1, 2024

(30) Foreign Application Priority Data
Apr. 4, 2023 (JP) 2023-060590
Mar. 6, 2024 (JP) 2024-033657

(51) Int. Cl. B41J 2/18; B41J 2/165; B41J 2/21

(52) U.S. Cl. CPC B41J 2/18; B41J 2/16532; B41J 2/2103; B41J 2/2117

(57) ABSTRACT

An object is to optimize the time of ink circulation by a configuration that regularly circulates an ink for agitation without decreasing the capacity of production of printed objects. To achieve this, in a case where an ink discharge operation of discharging an ink from an ejection port is performed between the last circulation operation and the next circulation operation, the circulation time in the next circulation operation is corrected.

### BACKGROUND OF THE INVENTION

### Field of the Invention

The present invention relates to a printing apparatus that performs printing by using an ink and to an ink circulation method.

### Description of the Related Art

In recent years, using pigment inks, which are superior to dye inks in durability, has become mainstream in printing of images to be displayed outdoors. In a case of using a pigment ink with an inkjet printer to perform printing, the pigment component in the pigment ink may precipitate inside a supply channel, which may cause nonuniform printing density, defective ejection, clogging of ejection ports, and so on.

Japanese Patent Laid-Open No. 2017-132096 discloses a method in which a circulating pump is regularly driven to circulate a pigment ink inside a supply channel and agitate the pigment ink, thereby preventing or reducing precipitation in the pigment ink inside the supply channel.

In the method of Japanese Patent Laid-Open No. 2017-132096, a circulation operation is repetitively performed for a certain time at regular intervals. Here, in a case where an ink discharge operation, such as a printing operation, is performed between regular circulation operations, the printing operation itself also exerts an agitation effect, which partly eliminates the precipitation of the pigment component. Accordingly, the regular circulation in Japanese Patent Laid-Open No. 2017-132096 is performed more than necessary. This may decrease the capacity of production of printed objects.

Here, considering the service life of the circulating pump, it is desirable for the operation time of the circulating pump to be shorter. Also, since no printing operation can be performed during circulation, it is desirable for the time each circulation operation to be short from the viewpoint of shortening the time required before printing. The configuration in Japanese Patent Laid-Open No. 2017-132096 does not optimize the ink circulation time t0 address such circumstances.

### SUMMARY OF THE INVENTION

In view of the above, the present invention provides a printing apparatus and an ink circulation method that optimize the time of ink circulation by a configuration that regularly circulates an ink for agitation without decreasing the capacity of production of printed objects.

To this end, the printing apparatus of the present invention includes: an ejection unit that ejects an ink from an ejection port; a circulation unit that performs a circulation operation of regularly circulating the ink through a predetermined circulation channel; and a setting unit that sets a circulation time for which the circulation unit will perform a next circulation operation, and the setting unit sets the circulation time such that the circulation time in a case where an ink discharge operation of discharging the ink from the ejection port is performed between a last circulation operation and the next circulation operation is shorter than the circulation time in a case where the ink discharge operation is not performed between the last circulation operation and the next circulation operation.

In accordance with the present invention, it is possible to provide a printing apparatus and an ink circulation method capable of lengthening the pump service life and lessening the decrease in production capacity.

Further features of the present invention will become apparent from the following description of exemplary embodiments with reference to the attached drawings.

### BRIEF DESCRIPTION OF THE DRAWINGS

FIG. 1 is a schematic perspective view illustrating an inkjet printing apparatus;

FIG. 2A is a schematic view illustrating an ink supply channel;

FIG. 2B is a schematic view illustrating an ink supply channel;

FIG. 3 is a block diagram illustrating a configuration of a printing system;

FIG. 4 is a graph illustrating a relationship between the circulation flow velocity and the circulation time necessary for eliminating precipitation;

FIG. 5A is a timing chart illustrating a timing of regular circulation for an ink supply channel;

FIG. 5B is a timing chart illustrating a timing for regular circulation for the ink supply channel;

FIG. 6 is a flowchart illustrating a regular circulation time correction process; and

FIG. 7 is a flowchart illustrating a regular circulation time calculation process.

### DESCRIPTION OF THE EMBODIMENTS

An embodiment of the present invention will be described below with reference to the drawings.

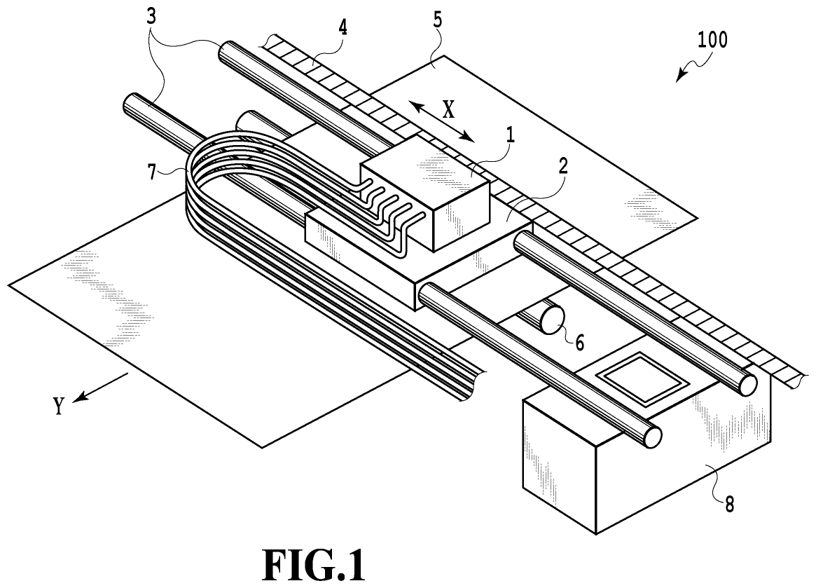

FIG. 1 is a schematic perspective view of an inkjet printing apparatus (hereinafter referred to also as “printing apparatus”) 100 in the present embodiment. The printing apparatus 100 includes a print head 1 capable of being mounted on and moving with a carriage 2 along guide rails 3, an endless belt 4 coupled to the carriage 2, and a conveyance roller 6 which conveys a print medium 5. The printing apparatus 100 further includes supply tubes 7 through which to supply inks to the print head 1, and a recovery processing apparatus 8 which recovers the ejection condition of the print head 1.

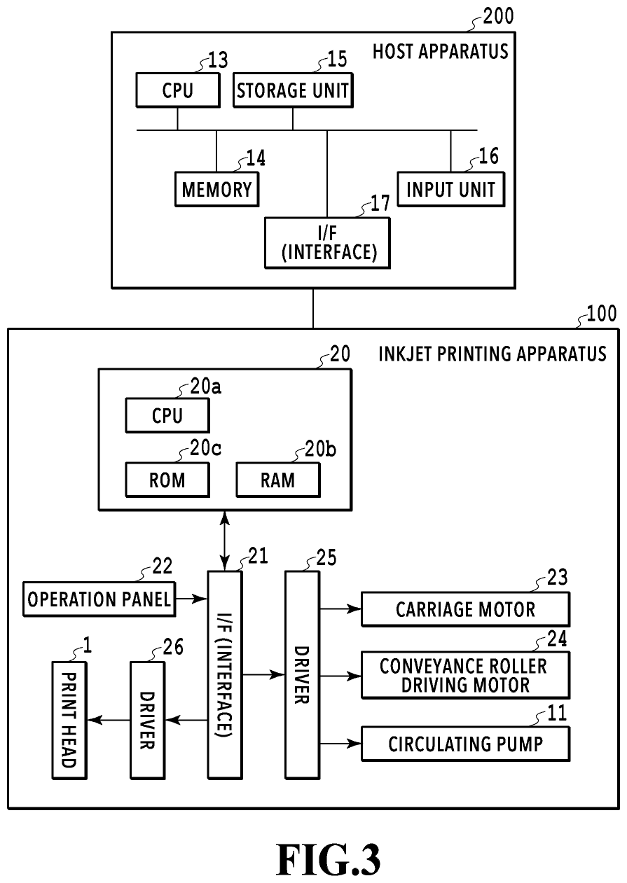

The printing apparatus 100 is a so-called serial-type printing apparatus which prints images by reciprocally moving the print head 1 in a main scanning direction (X direction). The print head 1 is an inkjet print head having multiple ejection port arrays each including multiple ejection ports through which an ink can be ejected, and is detachably mounted on the carriage 2. The carriage 2 reciprocally moves in the main scanning direction, which is the X direction. Specifically, the carriage 2 is supported so as to be movable along the guide rails 3 extending in the main scanning direction, and is coupled to the endless belt 4, which moves in parallel to the guide rails 3. The print head 1 reciprocally moves in the main scanning direction along with the carriage 2 in response to the endless belt 4 reciprocally moving with a driving force from a carriage motor 23 (see FIG. 3 to be mentioned later).

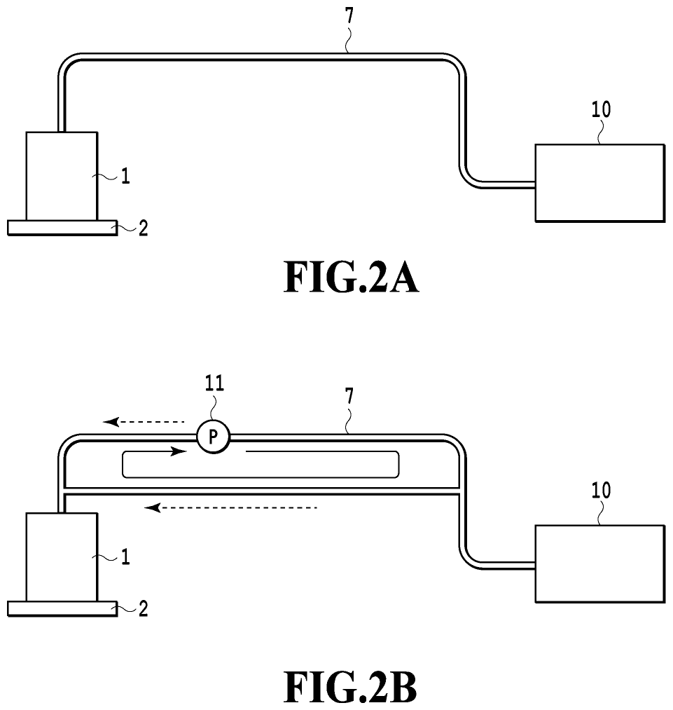

The print medium 5 is conveyed in a sub scanning direction (Y direction) crossing the main scanning direction (in FIG. 1, perpendicularly crossing the main scanning direction) by the conveyance roller 6. The multiple supply tubes 7 for colors of cyan, magenta, yellow, black, and white are connected to the print head 1. Each supply tube 7 is connected to a later-described ink tank 10 (see FIGS. 2A and 2B to be mentioned later) holding inks of the above colors, and forms an ink supply channel. Details of the ink supply channel will be described later. The ink of each color to be supplied to the print head 1 through the corresponding ink supply channel can be independently supplied to the corresponding ejection port array in the print head 1. In the present embodiment, the print head 1 includes ejection ports for all of the colors. Alternatively, separate print heads may each include ejection ports for one color.

The printing apparatus 100 prints an image on the print medium 5 by repeating a printing scan in which the carriage 2 is moved along with the print head 1 in the main scanning direction while causing the print head 1 to eject the inks, and an operation of conveying the print medium 5 in the sub scanning direction. Also, the main body of the printing apparatus 100 includes the recovery processing apparatus 8 for maintaining the ink ejection condition of the print head 1 well. The recovery processing apparatus 8 includes a capping mechanism capable of covering the ejection ports in the print head 1 with a cap, and a pump mechanism capable of sucking the inks from the ejection ports in the print head 1 through the cap. This makes it possible to perform an operation of sucking the inks from the ejection ports as a maintenance operation.

FIGS. 2A and 2B are schematic views each illustrating an ink supply channel formed between the print head 1 and the ink tank 10. FIG. 2A illustrates the ink supply channel used for the ink of one color among the ink supply channels for the cyan, magenta, yellow, and black color inks. The ink supply channel is formed by connecting the print head 1 and the ink tank 10 by the corresponding supply tube 7.

FIG. 2B illustrates the ink supply channel for the white ink. An inorganic pigment made of titanium oxide or the like, which is used as a pigment for an ink of a white-based color, such as the white ink, is prone to precipitation as compared to pigments for inks of other colors. To address this, the print head 1 and the ink tank 10 are connected by the supply tube 7 to form a channel, and a circulating pump 11 is further provided at an intermediate portion of that channel to form an ink supply channel capable of ink circulation. The solid arrow in FIG. 2B indicates the flow of the ink circulated as a result of actuating the circulating pump 11. Circulation through the ink supply channel as described above will eliminate the precipitation in the ink.

In response to the print head 1 performing an ink discharge operation, such as a printing operation, the same amounts of the inks as the discharged amounts are supplied to the print head 1 from the ink tank 10 through the corresponding ink supply channels. The ink supply channel with a circulation channel as illustrated in FIG. 2B also supplies the ink in a similar manner to the ink supply channels without a circulation channel.

The dashed arrows in FIG. 2B indicate the ink flow through the ink supply channel during an ink discharge operation. During an ink discharge operation, the ink is supplied also from the channel in the ink supply channel on the side where the circulating pump 11 is connected. In the present embodiment, an ink discharge operation, which is performed by driving the circulating pump 11, is not performed during an ink discharge operation since doing so will interfere with the ink supply to the print head 1.

In FIG. 2B, the circulation channel is formed by a supply tube between the print head 1 and the ink tank 10. Alternatively, a configuration to agitate the ink inside the print head 1 or the ink tank 10 may be employed. Also, in the present embodiment, only the supply channel for the white ink is employed as an ink supply channel with a circulation configuration as illustrated in FIG. 2B, but the supply channels for the other inks may be employed as such ink supply channels.

FIG. 3 is a block diagram illustrating a configuration of a printing system in the present embodiment. The printing system in the present embodiment includes a host apparatus 200 and the printing apparatus 100. The host apparatus 200 is an apparatus to be connected to the inkjet printing apparatus (printer). A personal computer, a digital camera, or the like that can function as an information processing apparatus is usable as the host apparatus 200. The host apparatus 200 includes a central processing unit (CPU) 13, a memory 14, a storage unit 15, an input unit 16 including a keyboard, a mouse, and the like, and an interface (I/F) 17 for communicating with the printer.

The user can create image data to be output from the printing apparatus 100 by executing a program (application) stored in the memory 14. The CPU 13 executes various processes in accordance with the program stored in the memory 14, and executes image processing such as color processing and quantization processing on image data input by the user. The print data obtained as a result of performing the image processing is sent to the inkjet printing apparatus connected to the host apparatus 200 via the I/F 17.

The printing apparatus 100 includes a control unit 20 having a CPU 20a, such as a microprocessor, and a random-access memory (RAM) 20b that is used as a work area for the CPU 20a and is responsible for storage of various data such as print data and registration adjustment values and the like. The control unit 20 further includes a read-only memory (ROM) 20c storing a control program for the CPU 20a and various data. The printing apparatus 100 further includes an I/F 21, an operation panel 22, and drivers 25 and 26. The driver 25 controls the driving of the motor 23 for driving the carriage, a motor 24 for driving the conveyance roller, and the circulating pump 11 for an ink supply channel. The driver 26 drives the print head 1.

The print data sent from the host apparatus 200 and received via the I/F 21 of the inkjet printing apparatus is stored in the RAM 20b of the control unit 20. In accordance with the print data stored in the RAM 20b, the control unit 20 outputs on-off signals for driving the motors 23 and 24 to the driver 25 and outputs an ejection signal and the like to the driver 26 to form an image on a print medium. Also, by following the control sequence to be described later, the control unit 20 outputs an on-off signal for regularly driving the circulating pump 11 to the driver 25 to control the circulating pump 11.

In the present embodiment, in a case where white ink is left unused in the ink supply channel for a certain time without circulation or the like, the pigment component precipitates. Performing printing in this state may result in image unevenness. To maintain the quality of printing with the white ink, it is necessary to make the ink supply channel a channel capable of circulation and agitate the white ink in the channel by the circulation (ink circulation for a predetermined time).

While the circulating pump 11 as mentioned earlier is used to circulate the ink inside the ink supply channel, the service life of the circulating pump 11 will be shorter if the circulating pump is constantly used to circulate the ink. To address this, regular circulation control is performed in which a circulation operation is repetitively turned on and off at intervals of a certain time. In the present embodiment, the regular circulation is performed in a time period in which an image is not printed.

In such control, the time required for the circulation is preferably set based on the ink's characteristics (such as the proportion of the contained pigment). Also, it is desirable to set a circulation time that allows the ink to be agitated to such an extent that a printed product obtained by printing with the ink in the agitated state after turning off the circulating pump 11 has a level of quality acceptable to the user.

Next, a description will be given of a relationship between the circulation flow velocity and the circulation time in the circulation channel in the present embodiment that are necessary for eliminating the precipitation of the pigment component in the ink.

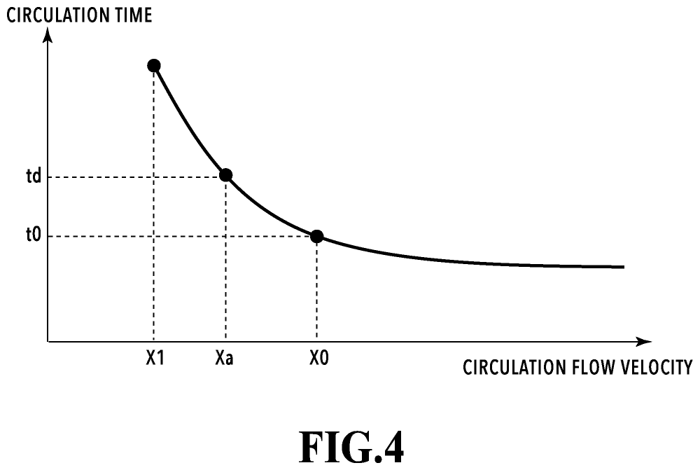

FIG. 4 is a graph illustrating the relationship between the circulation flow velocity and the circulation time necessary for eliminating the precipitation in the ink left unused in the supply tube 7 without circulation for a time T0 [s]. The horizontal axis represents the circulation flow velocity, and the vertical axis represents the circulation time. In the present embodiment, for example, the time for which a circulation operation has not been performed before starting regular circulation is the time T0 [s], and the precipitation of the pigment component can be eliminated by setting the circulation flow velocity and the circulation time with the circulating pump 11 to a flow velocity X0 [m/s] and a time t0 [s], respectively.

The graph also indicates that the relationship between the circulation flow velocity and the circulation time is such that the higher the circulation flow velocity, the shorter the circulation time necessary for eliminating the precipitation. Note that the precipitation in the ink cannot be eliminated in a case where the circulation flow velocity is less than a certain velocity. This is because the low ink circulation flow velocity cannot give a sufficient force to agitate the precipitated pigment component within the ink liquid again. For this reason, the circulation flow velocity must be a flow velocity X1 [m/s] or more.

The precipitation inside the ink supply channel can be eliminated by performing circulation satisfying predetermined conditions for the time and the flow velocity as described above.

Here, the ink inside the ink channel moves as the print head 1 discharges the ink. In a case where a certain amount of the ink continues to be discharged for a certain time in an ink discharge operation, the ink inside the supply channel moves at a certain flow velocity. This brings about the same ink agitation effect as that achieved by ink circulation. Specifically, the ink discharge operation exerts a certain precipitation elimination effect on the ink inside the channel. Thus, in a case where the ink discharge operation is performed between regular circulation operations, then, the precipitation in the ink will already be partly eliminated when the second (next) regular circulation is performed. Accordingly, the circulation time of the next regular circulation can be corrected to a shorter time.

Thus, in the present embodiment, in a case where an ink discharge operation, such as an image printing operation, is performed between regular circulation operations, the second (next) regular circulation will be performed with the agitation effect of the ink discharge operation taken into account. A method for this will now be described below.

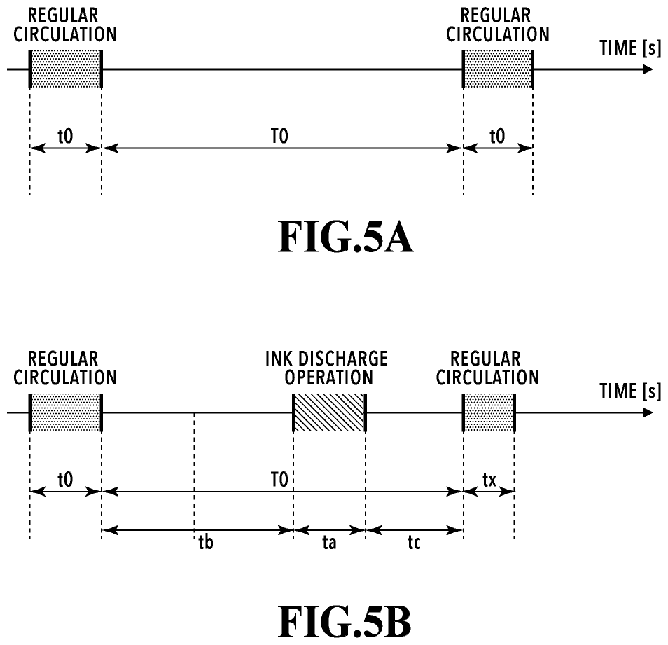

FIGS. 5A and 5B are timing charts each illustrating a timing of regular circulation for the ink supply channel performed in the present embodiment. FIG. 5A illustrates a case of performing no ink discharge operation between regular circulation operations. FIG. 5B illustrates a case of performing an ink discharge operation between regular circulation operations. In FIG. 5A, regular circulation is performed for the time t0 [s], and then the ink is left unused for the time T0 [s]. Thereafter, the next regular circulation is performed for the time t0 [s]. In FIG. 5B, regular circulation is performed for the time to [s], and then the ink is left unused for a time tb [s] without circulation. Thereafter, an ink discharge operation is performed for a time ta [s]. After the ink discharge operation, the ink is left unused for a time tc [s] without circulation, and then regular circulation is performed for a time tx [s]. Taking into account the ink precipitation elimination effect of the ink discharge operation, the time tx [s] of this regular circulation can be set shorter than the time t0 [s] of the regular circulation before which no ink discharge operation was performed. In the present embodiment, in a case where the time of T0 [s] elapses while the ink discharge operation is performed, regular circulation is performed after the ink discharge operation ends. In a case of receiving an instruction to perform an ink discharge operation, e.g., receiving an image printing instruction, from the user during regular circulation, the designated ink discharge operation will be performed after the regular circulation ends.

Note that the ink discharge operation mentioned above is not limited to ink ejection from the print head 1 for printing an image, but also includes a suction recovery operation of discharging the ink from the ejection ports by suction to recover the ejection condition of the print head 1, a preliminary ejection operation of preliminarily ejecting the ink, and so on.

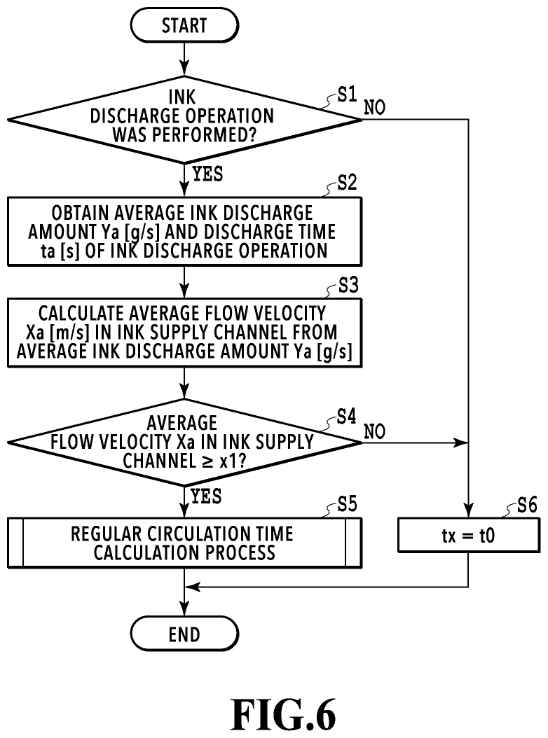

FIG. 6 is a flowchart illustrating a regular circulation time correction process in the present embodiment. The regular circulation time correction process is a process which is always performed before performing regular circulation (when the time T0 [s] elapses after the end of the last regular circulation). The regular circulation time correction process in the present embodiment will now be described below using the flowchart of FIG. 6. The CPU 20a of the printing apparatus 100 performs the series of processes illustrated in FIG. 6 by loading program code stored in the ROM 20c to the RAM 20b and executing it. Alternatively, the functions of some or all of the steps in FIG. 6 may be implemented with hardware such as an application-specific integrated circuit (ASIC) or an electronic circuit. Meanwhile, the symbol “S” in the description of each process means a step in the flowchart.

Upon start of the regular circulation time correction process, it is determined in S1 whether an ink discharge operation was performed after the last regular circulation operation. If no ink discharge operation was performed (No), the process proceeds to S6 to set the time tx [s] of the regular circulation to the predetermined time t0 [s], and the process is terminated. If an ink discharge operation was performed (Yes), the process proceeds to S2 to obtain information on an average ink discharge amount Ya [g/s] per unit time in the ink discharge operation and the discharge time ta [s]. For example, in a case where the ink discharge operation was a printing operation, the average ink discharge amount Ya [g/s] can be derived from the image data. In a case where the ink discharge operation was a suction recovery operation, the average ink discharge amount Ya [g/s] can be derived from a suction amount set in advance. Thereafter, in S3, an average flow velocity Xa [m/s] in the ink supply channel in the ink discharge operation is calculated from the obtained average ink discharge amount Ya [g/s].

Specifically, the average flow velocity Xa [m/s] can be calculated from the average ink discharge amount (amount of the ink discharged), the sectional area of the supply tube 7 forming the ink supply channel, and the specific gravity of the ink. The sectional area of the supply tube 7 forming the ink supply channel and the specific gravity of the ink are fixed values. For this reason, in the present embodiment, a conversion factor that can be derived from these fixed values is stored in the RAM 20b in advance, and the average ink discharge amount Ya [g/s] obtained in S2 is multiplied by the conversion factor to calculate the average flow velocity Xa [m/s]. In other words, the average flow velocity Xa [m/s] has a linear relationship with the average ink discharge amount Ya [g/s].

Thereafter, in S4, it is determined whether or not the average flow velocity Xa [m/s] calculated in S3 is more than or equal to the flow velocity X1 [m/s], which is the lowest flow velocity that can achieve a precipitation elimination effect. If the average flow velocity Xa [m/s] is not more than or equal to the flow velocity X1 [m/s] (No), the time tx [s] of the regular circulation is set to the predetermined time t0 [s] since the agitation effect achieved by the performed ink discharge operation was low. The process is then terminated. If the average flow velocity Xa [m/s] is more than or equal to the flow velocity X1 [m/s] (Yes), the process proceeds to S5 to perform a regular circulation time calculation process, and then the process is terminated. Since the average flow velocity Xa [m/s] has a linear relationship with the average ink discharge amount Ya [g/s], the above determination may be made by comparing the average ink discharge amount Ya [g/s] with a predetermined amount.

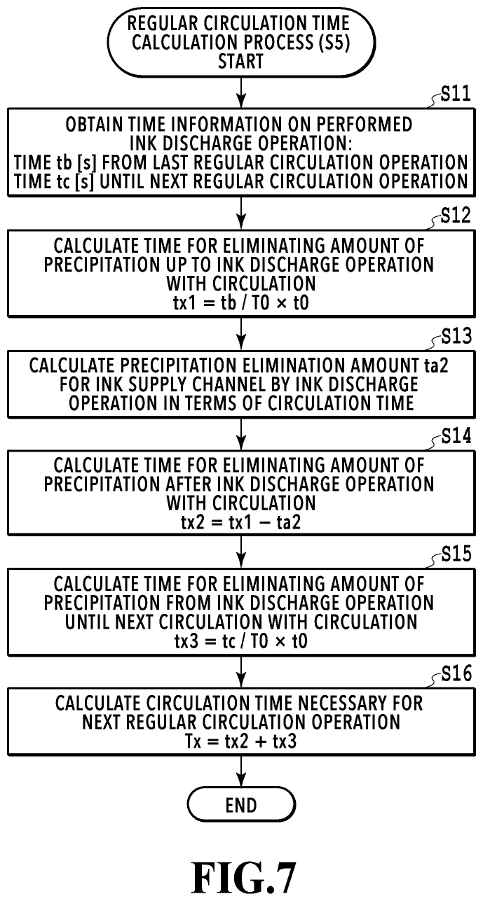

FIG. 7 is a flowchart illustrating the regular circulation time calculation process in the present embodiment. The regular circulation time calculation process in the present embodiment will now be described below using the flowchart of FIG. 7.

Upon start of the regular circulation time calculation process, time information on the performed ink discharge operation is obtained in S11. Specifically, obtained are the time tb [s] until the ink discharge operation was performed after the last regular circulation, and the time tc [s] until the next regular circulation is performed after the end of the ink discharge operation. After this is S12 which involves calculating the time it takes to eliminate the amount of precipitation in the ink that occurred during the obtained time tb [s], which was the time until the ink discharge operation was performed, with the flow velocity of regular circulation.

As for the specific calculation, the amount of precipitation that occurs during the time T0 [s] without a circulation operation can be eliminated with the predetermined time t0 [s], as described above (see FIG. 4). Here, the predetermined time t0 [s] is an optimized circulation time derived by adding a margin to the shortest possible time with which the amount of precipitation that occurs during the time T0 [s] can be eliminated. Thus, a circulation time tx1 [s] for eliminating the precipitation that occurred during the time tb [s] mentioned above can be calculated as

$$tx 1 = tb / T 0 \times t 0.$$

Thereafter, in S13, a precipitation elimination amount, which is an amount of the precipitation in the ink supply channel eliminated by the ink discharge operation, is calculated. This precipitation elimination amount represents the ink discharge operation in terms of the length of time of circulation at the flow velocity of regular circulation.

As for the specific calculation, the average flow velocity in the ink discharge operation calculated in S3 in FIG. 6 is the flow velocity Xa [m/s]. Also, based on the relationship between the circulation flow velocity and the circulation time for eliminating precipitation illustrated in FIG. 4, the circulation time necessary for eliminating the precipitation in the case of the flow velocity Xa [m/s] can be calculated to be a time td [s]. The discharge time ta [s] of the ink discharge operation has already been obtained in S2 in FIG. 6. Thus, by calculating the precipitation elimination amount by the ink discharge operation in terms of a regular circulation time, that time ta2 [s] can be calculated as

$$ta 2 = ta / td \times t 0.$$

Then, in S14, a time tx2 [s] for eliminating the amount of precipitation remaining after the ink discharge operation with regular circulation is calculated from the calculated circulation time tx1 [s] and time ta2 [s]. Specifically, the time ta2 [s], which is the precipitation elimination amount by the ink discharge operation calculated in terms of a regular circulation time, is subtracted from the circulation time tx1 [s], which is a time for eliminating the precipitation that occurred during the time tb [s].

$$tx 2 = tx 1 - ta 2$$

With this equation, the time tx2 [s] for eliminating the amount of precipitation remaining after the discharge operation with regular circulation can be calculated.

In a case where the calculated time tx2 [s] is a negative value, it indicates that the ink inside the ink supply channel has been sufficiently agitated by the ink discharge operation. Thus, in the case the time tx2 [s] is a negative value, the time tx2 [s] is set to 0 (tx2=0).

Then, in S15, the time it takes to eliminate the amount of precipitation in the ink in the ink supply channel that occurred during the time tc [s], which is from the end of the ink discharge operation until the next regular circulation, with the flow velocity of regular circulation is calculated by the same method as S12. Specifically, the amount of precipitation that occurs during the time T0 [s] without a circulation operation can be eliminated by performing regular circulation for the time t0 [s] (see FIG. 4). Thus, a circulation time tx3 [s] for eliminating the precipitation that occurred during the time tc [s] can be calculated as

$$tx 3 = tc / T 0 \times t 0.$$

Then, in S16, a circulation time tx [s] necessary for the next regular circulation is calculated. Specifically, the circulation time tx [s] can be calculated as

$$tx = tx 2 + tx 3 ,$$

in which the time tx2 [s] for eliminating the amount of precipitation that remained after the ink discharge operation with the regular circulation is added to the circulation time tx3 [s] for eliminating the precipitation that occurred during the time tc [s].

After calculating the necessary circulation time in S16, the regular circulation time calculation process in S5 in FIG. 6 is terminated. In the regular circulation to be performed next, the circulation process will be performed for the regular circulation time tx [s] obtained in S5.

The present embodiment has been described by taking a serial-type printing apparatus, as an example, which performs printing by reciprocally moving the print head 1 and conveying a print medium. However, the present embodiment is not limited to this type and is also applicable to a line-type printing apparatus which performs printing on a conveyed print medium with a print head in which ejection ports are arrayed over the same length as the print medium.

Also, in the present embodiment, an example of circulating a white ink whose pigment is prone to precipitation has been described, but the present embodiment is not limited to this example. The present embodiment is also applicable to color inks containing pigments. Moreover, the inks do not necessarily have to be pigment inks as long as they are inks that need to be agitated.

Also, in the present embodiment, a description has been given of a configuration in which a circulation path is provided to a supply path connecting the ink tank 10 and the print head 1 and an ink is circulated through the circulation path. However, the present embodiment is not limited to this configuration. The present embodiment is also applicable to a configuration in which the circulation path also includes the inside of the print head, and to a configuration in which the ink is circulated inside the print head.

Also, in the present embodiment, a description has been given of correction of the circulation time in a case where the ink supply channel includes only one circulation channel. Alternatively, the ink supply channel between the print head 1 and the ink tank 10 may include two or more circulation channels.

Incidentally, in the case of applying the present embodiment to color inks, channels with a circulation configuration as illustrated in FIG. 2B, for example, are employed as the supply channels for the color inks, like the white ink. Moreover, based on the color inks' precipitability, parameters such as the lowest flow velocity X1 [m/s] that can provide a precipitation elimination effect, which is illustrated in FIG. 4, are held as different parameters from those for the white ink. As compared to the white ink using titanium oxide as described above, the color inks are less prone to precipitation. Accordingly, the value of the lowest flow velocity X1 [m/s] is smaller than the value for the white ink. The parameters adjusted to the color inks' precipitability are used to calculate the regular circulation time tx [s] described above. The regular circulation time tx [s] calculated in S5 in FIG. 6 is shorter for the color inks, which are less prone to precipitation, than for the white ink. Also, to in S6 in FIG. 6 may be shorter for the color inks than for the white ink. As described above, the calculated regular circulation time tx [s] is a numerical value different from that for the white ink. In this way, each ink's regular circulation can be performed independently.

The regular circulation time tends to be longer for the white ink since it is more prone to precipitation. However, the circulation time will be shorter for the white ink than for the color inks, for example, in a case where the white ink was intensively used in the printing and the color inks were not used much.

Incidentally, the longest regular circulation time among the regular circulation times calculated for the color inks and the white ink may be used as the circulation time for all inks. This makes it possible to implement a configuration that allows circulation of the inks of all colors with a single pump.

Also, in the present embodiment, an example in which a single ink discharge operation is performed between the last circulation operation and the next circulation operation has been described, but the present embodiment is not limited to this example. Multiple ink discharge operations may be performed between the last circulation operation and the next circulation operation. In this case, the processes of S12 and S13 may be performed multiple times for the respective ink discharge operations to calculate the circulation time necessary for the next regular circulation operation.

As described above, in the present embodiment, in a case where an ink discharge operation of discharging an ink from ejection ports is performed between the last circulation operation and the next circulation operation, the circulation time in the next circulation operation is corrected. This makes it possible to optimize the ink circulation time without decreasing the capacity of production of printed objects.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-060590 filed Apr. 4, 2023, and No. 2024-033657 filed Mar. 6, 2024, which are hereby incorporated by reference wherein in their entirety.

What is claimed is:

1. A printing apparatus comprising:
an ejection unit that ejects an ink from an ejection port;
a circulation unit that performs a circulation operation of regularly circulating the ink through a predetermined circulation channel; and
a setting unit that sets a circulation time for which the circulation unit will perform a next circulation operation, wherein
the setting unit sets the circulation time such that the circulation time in a case where an ink discharge operation of discharging the ink from the ejection port is performed between a last circulation operation and the next circulation operation is shorter than the circulation time in a case where the ink discharge operation is not performed between the last circulation operation and the next circulation operation.

2. The printing apparatus according to claim 1, wherein the setting unit sets the circulation time by correcting a predetermined time according to an amount of the ink discharged per unit time from the ejection port in the ink discharge operation.

3. The printing apparatus according to claim 2, wherein the setting unit corrects the predetermined time in the next circulation operation according to a time for which the ink is ejected from the ejection port in the ink discharge operation.

4. The printing apparatus according to claim 3, wherein the setting unit corrects the predetermined time in the next circulation operation according to a time from the last circulation operation to the ink discharge operation.

5. The printing apparatus according to claim 4, wherein the setting unit corrects the predetermined time in the next circulation operation according to a time from the ink discharge operation to the next circulation operation.

6. The printing apparatus according to claim 2, wherein the setting unit does not correct the predetermined time in a case where the amount of the ink discharged per unit time is less than a predetermined amount.

7. The printing apparatus according to claim 1, wherein the ink discharge operation is a printing operation of performing printing by ejecting the ink from the ejection port.

8. The printing apparatus according to claim 1, wherein the ink discharge operation is a recovery operation of recovering an ejection condition of the ejection unit by performing at least one of a suction operation of sucking the ink from the ejection port or a preliminary ejection operation of preliminarily ejecting the ink from the ejection port.

9. The printing apparatus according to claim 1, wherein the ink is a pigment ink.

10. The printing apparatus according to claim 1, wherein the ink is a white ink.

11. The printing apparatus according to claim 1, wherein
the ejection unit is capable of ejecting a first ink and a second ink different from the first ink, and
the circulation unit is capable of circulating the first ink and does not circulate the second ink.

12. The printing apparatus according to claim 1, wherein
the ejection unit is capable of ejecting a first ink and a second ink different from the first ink, and
the circulation unit circulates the first ink and the second ink.

13. The printing apparatus according to claim 12, wherein a circulation time for which the circulation unit circulates the first ink in the circulation operation is different from a circulation time for which the circulation unit circulates the second ink in the circulation operation.

14. The printing apparatus according to claim 1, wherein
the ejection unit is capable of ejecting a first ink and a second ink different from the first ink, and
the ejection unit is a print head having the ejection port for ejecting the first ink and the ejection port for ejecting the second ink.

15. The printing apparatus according to claim 1, wherein
the ejection unit is capable of ejecting a first ink and a second ink different from the first ink, and
the ejection unit includes a first print head having the ejection port for ejecting the first ink, and a second print head having the ejection port for ejecting the second ink.

16. The printing apparatus according to claim 1, wherein the ejection unit performs printing by ejecting the ink while being mounted on and moving with a carriage.

17. An ink circulation method for a printing apparatus that ejects an ink from an ejection port, comprising:
regularly circulating the ink through a predetermined circulation channel; and
setting a circulation time for which the circulating will be performed next,
the setting includes setting the circulation time such that the circulation time in a case where an ink discharge operation of discharging the ink from the ejection port is performed between the circulating performed last and the circulating to be performed next is shorter than the circulation time in a case where the ink discharge operation is not performed between the circulating performed last and the circulating to be performed next.
